(19) United States
(12) Patent Application Publication
(10) Pub. No.: US 2008/0209305 A1
(43) Pub. Date: Aug. 28, 2008

(54) VITERBI DECODING SYSTEM AND VITERBI DECODING METHOD

(75) Inventor: Takahiro SATO, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, Kawasaki (JP)

(21) Appl. No.: 12/035,534

(22) Filed: Feb. 22, 2008

(30) Foreign Application Priority Data
Feb. 27, 2007 (JP) JP2007-046528

(51) Int. Cl. G06F 11/00

(52) U.S. Cl. 714/790; 714/E11.007

(57) ABSTRACT

A depuncturing unit depunctures a punctured convolutional code sequence and outputs the result to a decoding execution unit. The decoding execution unit executes Viterbi decoding, and it includes an ACS processing unit with a variable radix. A radix control unit controls a radix of the ACS processing unit according to a puncturing rate indicating a degree of puncturing of the convolutional code sequence which is acquired by a header analysis unit in a subsequent stage, in such a way that the radix of the ACS processing unit is larger as the puncturing rate is higher.

### BACKGROUND OF THE INVENTION

1. Field of the Invention

The present invention relates to a technique for Viterbi decoding of a convolutional code sequence and, particularly, to a technique for Viterbi decoding of a punctured convolutional code sequence.

2. Description of Related Art

In the field of digital communication, a convolutional code is often used as an error correction code. FIG. 7 shows an example of a general convolutional encoder 300. The convolutional encoder 300 generates a convolutional code with a constraint length of 7 and a code rate of 1/3. The convolutional encoder 300 includes a plurality of adders 310 and a plurality of delay elements 320 (which are D-flip-flops indicated by symbols D in FIG. 7). A transmission data sequence Input D is encoded into three sequences of output signals, Output A, Output B and Output C by the convolutional encoder 300. Although the convolutional encoder 300 encodes Input D into three sequences of output signals, the number of sequences of output signals may be other than three depending on the structure of a convolutional encoder.

FIG. 8 shows the transmission data sequence Input D and the output signals Output A, Output B and Output C. The convolutional encoder 300 generates 3-bit output (e.g. a0, b0 and c0) for 1-bit input (e.g. d0).

In a communication system which uses a convolutional code, a transmitting end converts a transmission data sequence into a convolutional code by an encoder, then modulates an obtained code sequence and transmits a modulated wave through a transmission line. A receiving end demodulates the modulated wave which is transmitted through the transmission line into code sequences such as Output A, Output B and Output C shown in FIG. 8 and further performs decoding. As one of algorithms for the decoding, Viterbi algorithm is widely known (“A 140-Mb/S, 32-State, Radix-4 Viterbi Decoder”, IEEE Journal of Solid-State Circuits, Vol 27, No. 12, December 1992). The Viterbi algorithm compares a received code sequence with every possible code sequence to be generated by an encoder of a transmitting end (which is referred to hereinafter as an expected code sequence). It thereby selects an expected code sequence which is closest to the received code sequence and decodes the selected code sequence to reproduce an original information sequence.

The Viterbi decoding implements decoding by three processing: calculation of a difference between a received code sequence and an expected code sequence (branch metric), repetition of ACS (Add-Compare-Select), and trace-back to finally decode data. Generally, a decision type which calculates a branch metric using a Hamming distance is called hard decision, and a decision type which calculates a branch metric using a Euclidean distance is called soft decision. Although the hard decision type requires a smaller amount of calculation than the soft decision type, which allows power saving, the hard decision type has lower error correction capability than the soft decision type. Therefore, for better performance of a receiver, a receiver of the soft decision type with higher error correction capability is generally used.

Recently, in a UWB (Ultra Wide Band) communication system which employs MB-OFDM (Multi-Band Orthogonal Frequency Division Multiplex) that is expected to be widely used as PAN (Personal Area Network), it is required to achieve high throughput and high error correction capability with a low transmission power. Further, since the implementation into a mobile terminal is assumed for this communication system, it is also required to achieve low power consumption in addition to the high error correction capability.

Japanese Unexamined Patent Application Publication No. 2001-28550 discloses a technique of performing ACS processing in stages using ACS processing blocks with a small radix arranged in cascade. The technique reduces the number of accesses to memory compared with a technique of completing ACS processing using one ACS processing block with a large radix, and it is thereby possible to suppress power consumption. It is also possible to further suppress power consumption by bypassing some ACS processing blocks and suspending the operation of the bypassed ACS processing blocks for a code sequence with a short constraint length.

Recently, in order to improve the communication efficiency, there is a technique of performing puncturing (bit elimination) on a code sequence which is obtained by a convolutional encoder so as to reduce the amount of transmitting data before transmission. A Viterbi decoder which receives such a punctured code sequence needs to perform depuncturing to complement a punctured bit before performing decoding.

FIG. 9 schematically shows the processing of performing puncturing on code sequences which are obtained as a result of encoding Input D by the encoder 300 shown in FIG. 7 to obtain output signals Output, and the processing of performing depuncturing by a Viterbi decoder.

The encoder 300 generates a convolutional code with a constraint length of 7 and a code rate of 1/3. Thus, 3-bit output (e.g. a0, b0 and c0) is obtained from 1-bit transmission data sequence Input D (e.g. d0).

In FIG. 9, the black squares indicate punctured bits. If the puncturing processing which eliminates c0 is performed on 3 bits (a0, b0 and c0), an output signal Output has 2 bits (a0 and b0) as shown in the left column of FIG. 9. Because 2-bit output is obtained from 1-bit input Input D, a final code rate R is 1/2.

In FIG. 9, a final code rate becomes higher toward the right side of the table. For example, in the case of a final code rate R=5/8, Input 5 bits are encoded into 15 (5×3) bits, of which 7 bits are then punctured, so that Output is 8 bits.

Likewise, in the case of a final code rate R=3/4, Input 3 bits are encoded into 9 bits, of which 5 bits are then punctured, so that Output is 4 bits.

A comparison in the degree of puncturing for each final code rate R is as follows. In the case of a final code rate R=1/2, 5/8 and 3/4, for 45 bits of an unpunctured code sequence, 15 bits, 21 bits and 25 bits are punctured, respectively. Specifically, if a code rate before puncturing is the same (which is 1/3 in this example), a final code rate becomes larger as the degree of puncturing is larger. In the following description, the final code rate is referred to as a code rate of an encoder which implements puncturing.

As shown in the lowermost row of FIG. 9, the depuncturing processing in a Viterbi decoder complements a punctured bit in a punctured code sequence with a complementary bit which is normally 0, thereby setting the code sequence back to the state before the puncturing. After that, the Viterbi decoder performs a normal Viterbi decoding of the depunctured code sequence.

When performing the Viterbi decoding of a punctured convolutional code sequence, because a complementary bit which is complemented by the depuncturing processing is “0” while a bit which actually contributes to likelihood calculation in ACS processing is data other than “0”, the reliability of the likelihood calculation is low. The reliability of the likelihood calculation depends on the value of a radix in the ACS processing. The case of a final code rate R=3/4 shown in FIG. 9 is described hereinafter as an example.

Consider first the case where a radix of the ACS processing is 2. At time t0, three bits of “a0”, “b0” and a complementary bit “0” which is inserted by the depuncturing are used for the likelihood calculation. At the next time t1, two complementary bits “0” and one bit “c1” are used. Because there is only one complementary bit and two actually available bits (“a0” and “b0”) in the case of the time t0, the reliability of the likelihood calculation is higher than the case of the time t1 where there are two complementary bits and only one actually available bit (“c1”) The reliability of the likelihood calculation is thus not constant, which causes degradation of the error correction capability of the Viterbi decoding.

On the other hand, if a radix of the ACS processing is 4, the likelihood calculation is not performed at the time t0, and it is performed at the time t1, so that three bits of “a0”, “b0” and “c1” can be used. Thus, the reliability of the likelihood calculation is higher, and thus the error correction capability is also higher in this case compared with the case were the radix is 2.

FIG. 10 shows simulation results of BER (Bit Error Rate), which is a ratio of the number of bit errors and the total number of transmitted bits, in the Viterbi decoding of a punctured convolutional code sequence with a code rate of 3/4 and a constraint length of 7 where a radix of ACS processing in a Viterbi decoder is 2 and 4. In FIG. 10, the horizontal axis indicates CNR (Carrier to Noise Ratio), which is a ratio of a carrier power and a noise power, and the vertical axis indicates BER. When the radix is 4, the bit error rate BER is smaller and thus the error correction capability is higher than when the radix is 2.

Thus, the reliability of the likelihood calculation in the ACS processing for the Viterbi decoding of a punctured convolutional code sequence is higher as a radix is larger. Accordingly, the reliability can be enhanced by increasing the value of a radix.

As described above, the technique disclosed in Japanese Unexamined Patent Application Publication No. 2001-28550 allows reduction of power consumption by dividing the ACS processing into a plurality of stages and reducing the number of accesses to memory. However, in the application of this technique to the decoding of a punctured convolutional code sequence, merely increasing a total radix (a sum of the radix in each processing stage) in the ACS processing for higher error correction capability causes a decrease in the effect of reducing power consumption due to glitch propagation.

The glitch propagation is caused by switching of an AND/OR gate or the like which constitutes a circuit, and it increases as the path of a combinational circuit is longer. Because an increase in a radix of ACS processing consequently increases the number of arithmetic bits and thereby lengthens the path of a combinational circuit, the glitch propagation is likely to occur, and power consumption becomes higher. Particularly, in a soft-decision Viterbi decoder with high error correction capability, an increase in power consumption due to glitch propagation is dominant, so that the effect of suppressing power consumption by the reduction of memory accesses decreases. Control of a radix in ACS processing is a key to achieve efficient decoding in light of the trade-off between the increase in power consumption due to glitch propagation and the improvement in error correction capability in a Viterbi decoder.

### SUMMARY

According to an embodiment of the present invention, there is provided a decoding method comprising changing a radix of ACS processing in accordance with a puncturing rate of data to be decoded.

The technique of the present invention enables efficient decoding of a punctured convolutional code sequence through the control of a radix of ACS processing.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a receiver according to an embodiment of the present invention;

FIG. 2 is a view showing a digital signal processing unit in the receiver shown in FIG. 1;

FIG. 3 is a view showing an example of a flame structure of an RF signal;

FIG. 4 is a view showing a detail of a decoding execution unit in the digital signal processing unit shown in FIG. 2;

FIG. 5 is a flowchart showing a process flow of a radix control unit in the decoding execution unit shown in FIG. 4;

FIG. 6 is a flowchart showing a process flow of a radix control unit according to another embodiment of the present invention;

FIG. 7 is a view showing an example of a convolutional encoder;

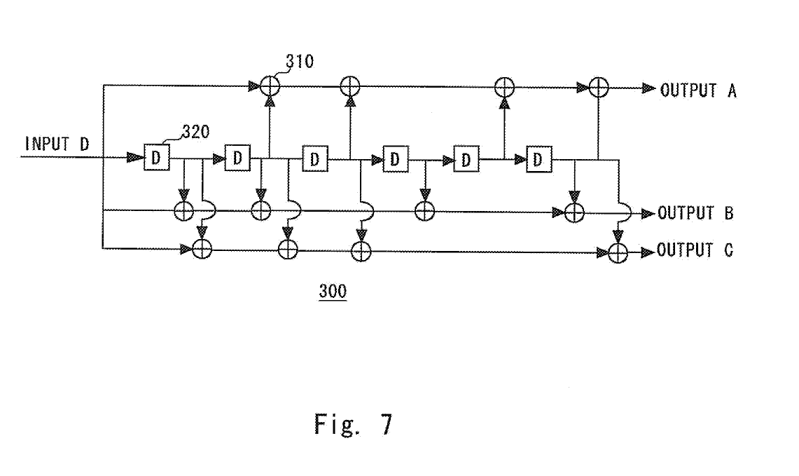

FIG. 8 is a view showing a convolutional code sequence which is obtained by the encoder shown in FIG. 7;

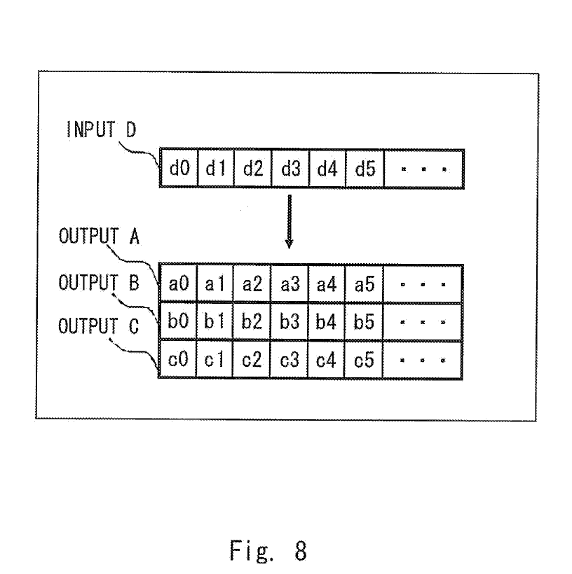

FIG. 9 is a view to describe puncturing and depuncturing; and

FIG. 10 is a view showing a relationship between a radix of ACS processing and a bit error rate when decoding a punctured convolutional code sequence.

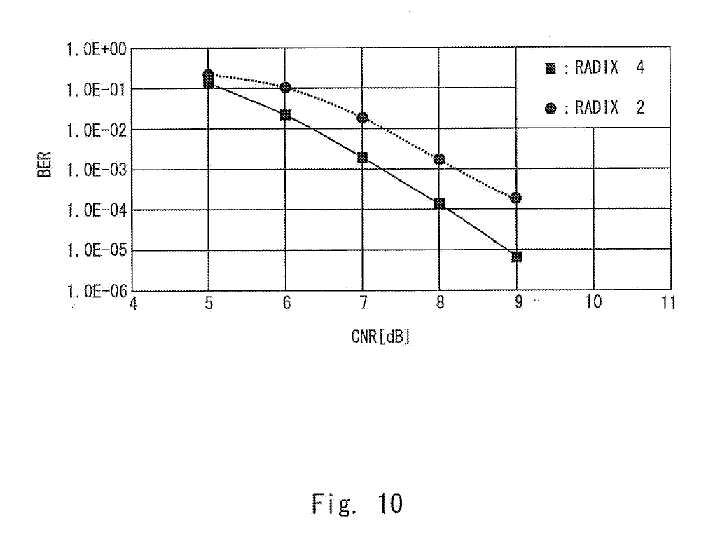

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

An embodiment of the present invention is described hereinafter with reference to the drawings.

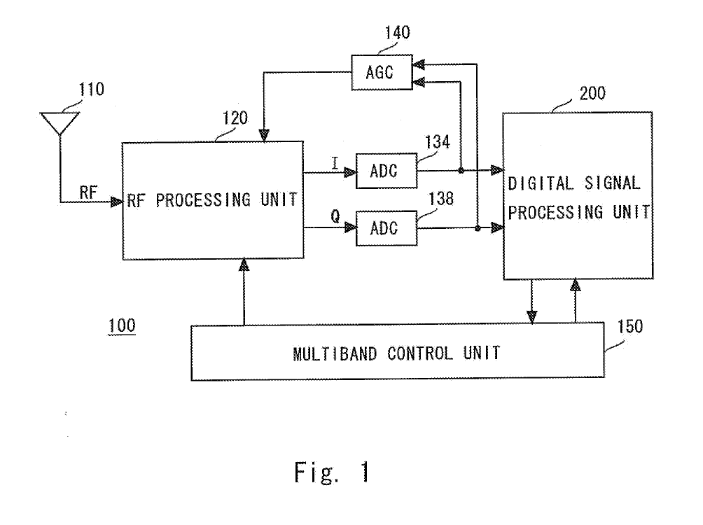

FIG. 1 shows a receiver 100 according to an embodiment of the present invention. The receiver 100 is such that a Viterbi decoding technique of the present invention is applied to a receiving end of a MB-OFDM communication system. The receiver 100 includes an antenna 110 that acquires a communication signal (RF signal), an RF processing unit 120 that converts an RF signal acquired via the antenna 110 into a complex baseband signal by direct conversion to obtain an I-axis signal and a Q-axis signal, A/D converters ADC 134 and ADC 138 that convert the I-axis signal and the Q-axis signal into digital signals, a digital signal processing unit 200 that processes the digital signals, and a multiband control unit 150. The receiver 100 also includes an AGC 140 that controls the gain of a VGA (Variable Gain Amplifier) which is included in the RF processing unit 120 though not shown.

The RF processing unit 120 is the same as a general RF processing unit which is used in a receiver of a MB-OFDM communication system and thus not described in detail herein.

The AGC 140 receives outputs of the ADC 134 and the ADC 138 and controls the gain of the VGA in the RF processing unit 120 so as to effectively use the dynamic range of the A/D converters.

In a MB-OFDM communication system, signals are transmitted with multiband frequency hopping. Thus, following the hopping of signals, the multiband control unit 150 outputs processing timing signals to functional blocks in the receiver 100 and controls their processing timing.

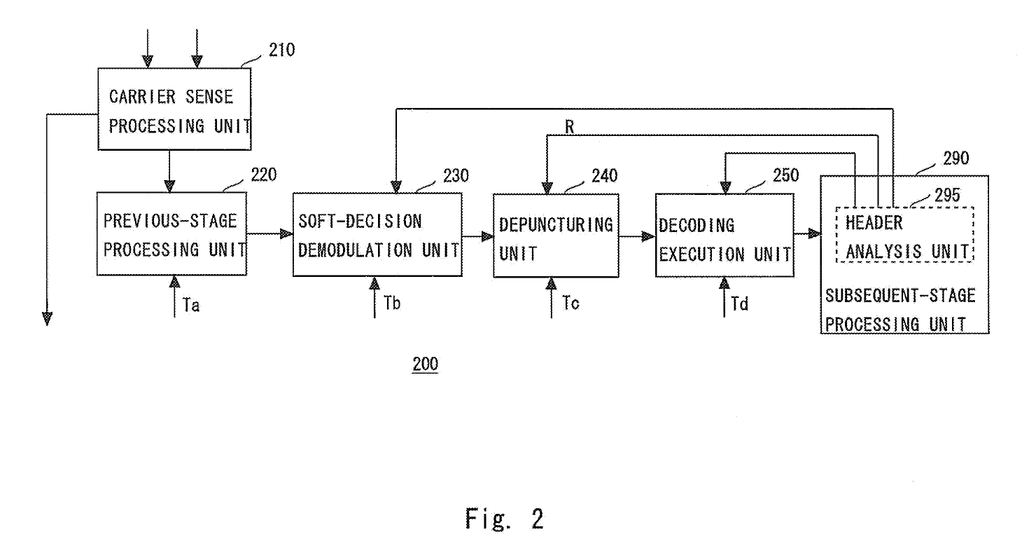

FIG. 2 shows the digital signal processing unit 200. The digital signal processing unit 200 includes a carrier sense processing unit 210, a previous-stage processing unit 220, a soft-decision demodulation unit 230, a depuncturing unit 240, a decoding execution unit 250, and a subsequent-stage processing unit 290. Before describing the functional blocks of the digital signal processing unit 200, a frame structure of an RF signal is described hereinbelow.

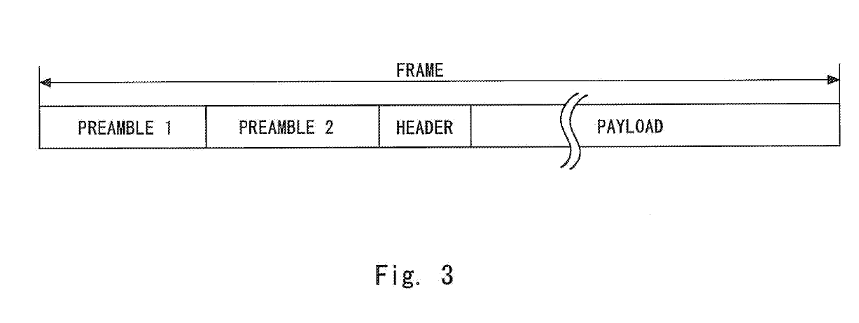

FIG. 3 is a pattern diagram showing a frame structure of an RF signal which is received by the receiver 100 of this embodiment. As shown in FIG. 3, the frame of the RF signal is composed of a preamble 1, a preamble 2, a header, and a payload.

The preamble 1 is used for synchronization processing such as frame synchronization, symbol synchronization, hopping synchronization and frequency synchronization in the carrier sense processing unit 210 of the digital signal processing unit 200. The preamble 2 is used for various corrections in the previous-stage processing unit 220.

The header includes demodulation parameters such as a payload length, a transmission rate and a modulation method and error correction encoding (decoding) parameters such as a constraint length and a code rate R.

Referring back to FIG. 2, the carrier sense processing unit 210 performs carrier sense processing on a complex baseband signal and detects the preamble 1 from the frame. The carrier sense processing unit 210 directs the multiband control unit 150 to perform frequency hopping at a timing which is determined by the carrier sense processing. The carrier sense processing unit 210 also performs correction of a frequency error between a transmitter and a receiver by AFC (Auto Frequency Control) processing in the process of the above-described synchronization processing.

The multiband control unit 150 controls the frequency hopping by controlling the oscillation frequency of a local oscillator (not shown) which is included in the RF processing unit 120 according to the direction of the carrier sense processing unit 210. Further, the multiband control unit 150 outputs processing timing signals Ta, Tb, Tc and Td to the previous-stage processing unit 220, the soft-decision demodulation unit 230, the depuncturing unit 240 and the decoding execution unit 250, respectively, to control their processing timings.

The previous-stage processing unit 220 performs discrete Fourier transform that converts a time-domain sequence into an equivalent frequency-domain sequence, characteristics correction of a transmission path by equalizing processing using an equalizer, correction of a phase distortion or a residual frequency error which is not eliminated by the carrier sense processing unit 210.

The data which is processed by the previous-stage processing unit 220 is then input to the soft-decision demodulation unit 230. The soft-decision demodulation unit 230 demodulates the input data by soft decision to obtain soft-decision demodulated data and outputs it to the depuncturing unit 240. The data which is output to the depuncturing unit 240 is a convolutional code sequence which is composed of the header and the payload in the frame shown in FIG. 3.

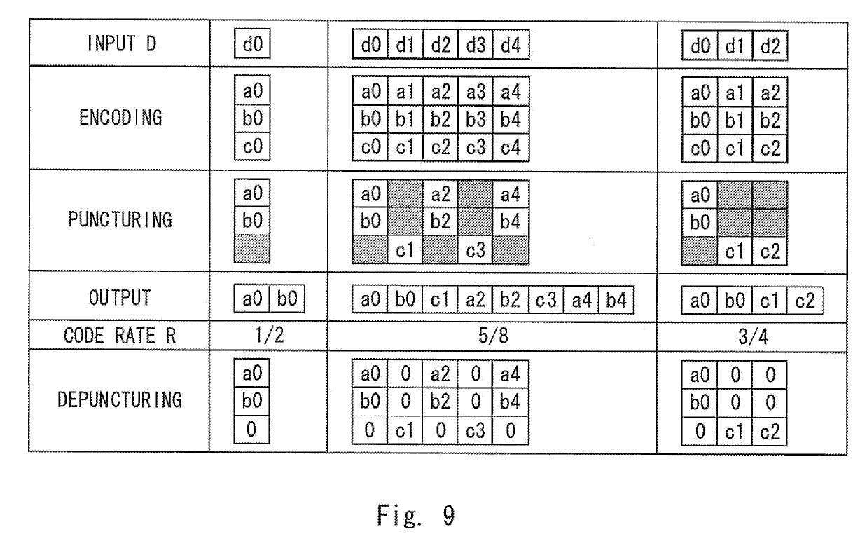

The soft-decision demodulated data which is obtained by the soft-decision demodulation unit 230 corresponds to Output shown in FIG. 9, and its bit width is the number of bits at the soft decision level. Because the Output of FIG. 9 is an example of a punctured convolutional code sequence, if a transmitted convolutional code sequence is not punctured, the soft-decision demodulated data which is obtained by the soft-decision demodulation unit 230 corresponds to an unpunctured code sequence shown in the second row of FIG. 9. Generally in the punctured convolutional code sequence, the payload portion is punctured but the header portion is not punctured.

Whether the depuncturing unit 240 performs depuncturing on the input data is controlled by a header analysis unit 295 in the subsequent-stage processing unit 290. The control by the header analysis unit 295 is described in detail later in the description of the subsequent-stage processing unit 290 below. Assume for here that the depuncturing unit 240 does not perform depuncturing processing on the header of the soft-decision demodulated data which is output from the soft-decision demodulation unit 230 and outputs it to the decoding execution unit 250 as it is.

The decoding execution unit 250 performs Viterbi decoding (error correction) on the header which is output from the depuncturing unit 240 and outputs decoded data to the subsequent-stage processing unit 290. The decoding execution unit 250 is described in detail later.

The subsequent-stage processing unit 290 performs processing such as descrambling, Reed-Solomon code decoding for improving receiving properties, and HCS (Header Check Sequence) for error detection on the decoded data. If an error is detected, it discards the frame. Those processing is the same as the equivalent processing in a known Viterbi decoding device and thus not described in detail herein.

The subsequent-stage processing unit 290 includes the header analysis unit 295. The header analysis unit 295 analyzes the decoded header to extract parameters which are necessary for the soft-decision demodulation unit 230, the depuncturing unit 240 and the decoding execution unit 250 to process the payload which is subsequent to the header, and outputs the parameters to a relevant processing unit or gives a direction based on the parameters to a relevant processing unit.

Specifically, the header analysis unit 295 directs the demodulation method of the payload to the soft-decision demodulation unit 230 based on the demodulation parameters, such as a length of the payload, a transmission rate and a modulation method, which are obtained as a result of analyzing the header.

Further, the header analysis unit 295 outputs the error correction parameters, such as a constraint length and a code rate R, which are obtained as a result of analyzing the header to the decoding execution unit 250. The header analysis unit 295 also determines whether the payload is punctured or not based on the code rate R, and if it is punctured, outputs the code rate R as a depuncturing direction to the depuncturing unit 240, so that depuncturing is performed. As described earlier, in the case of a punctured convolutional code sequence, the degree of puncturing a code sequence (puncturing rate) can be indicated by a code rate R. Thus, the header analysis unit 295 serves also as a puncturing rate acquisition unit.

The processing timing of the depuncturing unit 240 is controlled by a processing timing signal Tc from the multiband control unit 150. Whether to perform depuncturing is controlled based on the presence or absence of a depuncturing direction from the header analysis unit 295.

If the depuncturing unit 240 does not receive a depuncturing direction from the header analysis unit 295 at the timing of processing a payload, it outputs the payload as it is to the decoding execution unit 250. If, on the other hand, the depuncturing unit 240 receives a depuncturing direction, it performs depuncturing processing on the payload and outputs the result to the decoding execution unit 250.

The depuncturing processing by the depuncturing unit 240 inserts a complementary bit to the soft-decision demodulated data which corresponds to Output in FIG. 9. The punctured payload is thereby complemented as shown in the lowermost row of FIG. 9. A punctured pattern which indicates which bit is punctured is predetermined by specification or the like according to a code rate R in a transceiver and a receiver. Thus, the depuncturing unit 240 inserts a complementary bit according to the punctured pattern which is designated by the code rate R.

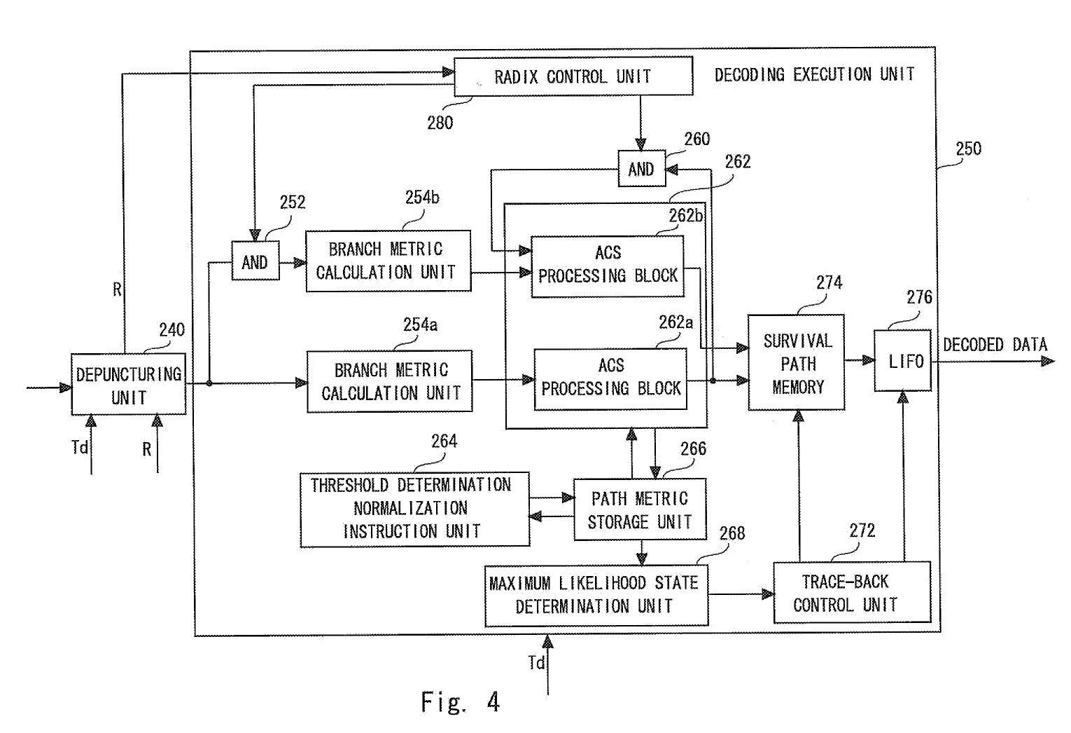

FIG. 4 shows a detailed structure of the decoding execution unit 250. The decoding execution unit 250 includes branch metric calculation units 254a and 254b, a threshold determination normalization instruction unit 264, an ACS processing unit 262, a radix control unit 280 that controls a radix of the ACS processing unit 262, a path metric storage unit 266, a maximum likelihood state determination unit 268, a survival path memory 274, a trace-back control unit 272, and a LIFO (Last-In First-Out memory) 276.

The ACS processing unit 262 includes a plurality of cascaded stages of ACS processing blocks, which are two cascaded stages of ACS processing blocks 262a and 262b in this example. Whether the ACS processing block 262b operates or not is controlled by the radix control unit 280. The radix of the ACS processing blocks 262a and 262b is 2, for example.

The branch metric calculation units 254a and 254b calculate a branch metric using the data which is output from the depuncturing unit 240. The calculation result of the branch metric calculation unit 254a is output to the ACS processing block 262a, and the calculation result of the branch metric calculation unit 254b is output to the ACS processing block 262b. Whether the branch metric calculation unit 254b operates or not is also controlled by the radix control unit 280.

The ACS processing block 262a performs ACS processing using a branch metric and a path metric which are output from the branch metric calculation unit 254a and the path metric storage unit 266, respectively, thereby calculating a path metric. When the ACS processing block 262b operates, the path metric which is calculated by the ACS processing block 262a is output to the ACS processing block 262b, so that the ACS processing block 262b further calculates a path metric. In this case, the radix of the ACS processing unit 262 is a sum of the radixes of the two processing blocks, which is 4, and the path metric which is obtained by the ACS processing unit 262 is the path metric which is output from the ACS processing block 262b.

On the other hand, when the ACS processing block 262b does not operate, the path metric which is obtained by the ACS processing unit 262 is the path metric which is output from the ACS processing block 262a.

The path metric and the survival path which are obtained by the ACS processing unit 262 are output to the path metric storage unit 266 and the survival path memory 274, respectively. The threshold determination normalization instruction unit 264 gives a normalization instruction to the path metric storage unit 266. In response thereto, the path metric storage unit 266 normalizes the path metric and stores the result.

The path metric storage unit 266, the maximum likelihood state determination unit 268, the trace-back control unit 272, the survival path memory 274 and the LIFO 276 obtain decoded data by trace-back processing and LIFO processing according to the survival path from the maximum likelihood state.

In this embodiment, the decoding execution unit 250 operates in the same manner as a known Viterbi decoding device except that the radix control unit 280 controls the radix of the ACS processing unit 262, so that the radix of the ACS processing unit 262 is variable by the control of the radix control unit 280. Thus, the detailed description is not provided herein and the above-mentioned operation is described hereinbelow.

The radix control unit 280 controls the radix of the ACS processing unit 262 through two AND gates 252 and 260. Specifically, when the radix of the ACS processing unit 262 is 4, the radix control unit 280 outputs High level to the two AND gates. The data from the depuncturing unit 240 is thereby input to the branch metric calculation unit 254b, so that the branch metric calculation unit 254b operates. Further, the output of the ACS processing block 262a is input to the ACS processing block 262b, so that the ACS processing block 262b operates.

On the other hand, when the radix of the ACS processing unit 262 is 2, the radix control unit 280 outputs Low level to the two AND gates. The data input to the branch metric calculation unit 254b and the ACS processing block 262b is there by masked, so that the branch metric calculation unit 254b and the ACS processing block 262b stop operating.

The radix control unit 280 controls the radix of the ACS processing unit 262 according to the degree of puncturing of the data which is output from the depuncturing unit 240. The data which is output from the depuncturing unit 240 to the decoding execution unit 250 is identified into three types: unpunctured header, unpunctured payload, and punctured payload.

As described earlier, the depuncturing unit 240 performs depuncturing processing only when it receives a depuncturing direction from the header analysis unit 295. When the depuncturing unit 240 receives a depuncturing direction from the header analysis unit 295, it performs depuncturing processing and transfers a code rate R which is contained in the depuncturing direction to the radix control unit 280.

When the radix control unit 280 does not receive a code rate R from the depuncturing unit 240, which is when the data to be processed by the decoding execution unit 250 is a header or an unpunctured payload, it sets the radix of the ACS processing unit 262 to be 2 or 4 according to a system designer. In terms of power saving, it is preferred to control the radix of the ACS processing unit 262 to be smaller, which is 2 in this case.

When the radix control unit 280 receives a code rate R from the depuncturing unit 240, which is when the data to be processed by the decoding execution unit 250 is a punctured payload, it sets the radix of the ACS processing unit 262 according to a puncturing rate which is indicated by the code rate R. Specifically, the radix control unit 280 sets the radix of the ACS processing unit 262 to be larger as the puncturing rate is higher. For example, if the puncturing rate is equal to or higher than a prescribed threshold, e.g. 5/8, the radix control unit 280 sets the radix of the ACS processing unit 262 to 4, and if the puncturing rate is lower than the prescribed threshold, it sets the radix of the ACS processing unit 262 to 2.

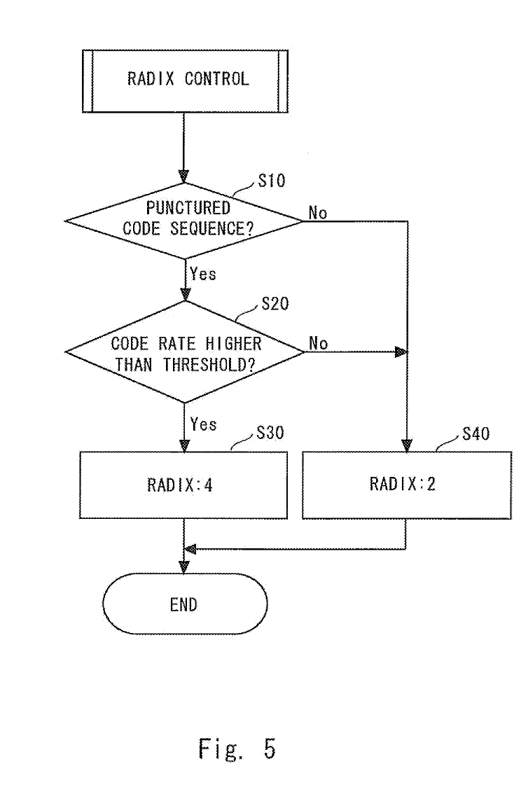

FIG. 5 is a flowchart showing the process flow of the control by the radix control unit 280. When the radix control unit 280 does not receive a code rate R from the depuncturing unit 240, which is when the data to be processed by the decoding execution unit 250 is an unpunctured code sequence (No in S10), the radix control unit 280 makes control in such a way that the radix of the ACS processing unit 262 is set to 2 (S40). On the other hand, when the radix control unit 280 receives a code rate R from the depuncturing unit 240, which is when the data to be processed by the decoding execution unit 250 is a punctured payload (Yes in S10), the radix control unit 280 makes control in accordance with the code rate R. Specifically, if the code rate R is lower than a prescribed threshold, the radix control unit 280 makes control in such a way that the radix of the ACS processing unit 262 is set to 2 (No in S20, S40). If the code rate R is equal to or higher than a prescribed threshold, the radix control unit 280 makes control in such a way that the radix of the ACS processing unit 262 is set to 4 (Yes in S20, S30).

As described in the foregoing, in the receiver 100 of this embodiment, the radix control unit 280 of the decoding execution unit 250 controls the radix of the ACS processing unit 262 according to a puncturing rate of a convolutional code sequence, so that the radix of the ACS processing unit 262 is larger as the puncturing rate is higher. This enables suppression of system power consumption when a code sequence has a low puncturing rate which achieves high error correction capability even with a small radix of ACS processing. This also achieves high error correction capability when a code sequence has a high puncturing rate. It is thereby possible to implement efficient decoding in spite of the trade-off between the power consumption and the error correction capability.

Although an embodiment of the present invention is described in the foregoing, the present invention is not restricted to the above-described embodiment, and various changes and modifications may be made without departing from the scope of the invention. All such changes and modifications as would be obvious to one skilled in the art are intended for inclusion within the scope of the present invention.

For example, for simplifying the description of the technique of the present invention, the ACS processing unit 262 includes two cascaded stages of ACS processing blocks with a radix of 2, and the radix control unit 280 controls the radix of the ACS processing unit 262 to be switched between 2 and 4 in the receiver 100 of the above-described embodiment. However, the number of stages of processing blocks in the ACS processing unit and the radix of each processing block are not limited to the above-described examples.

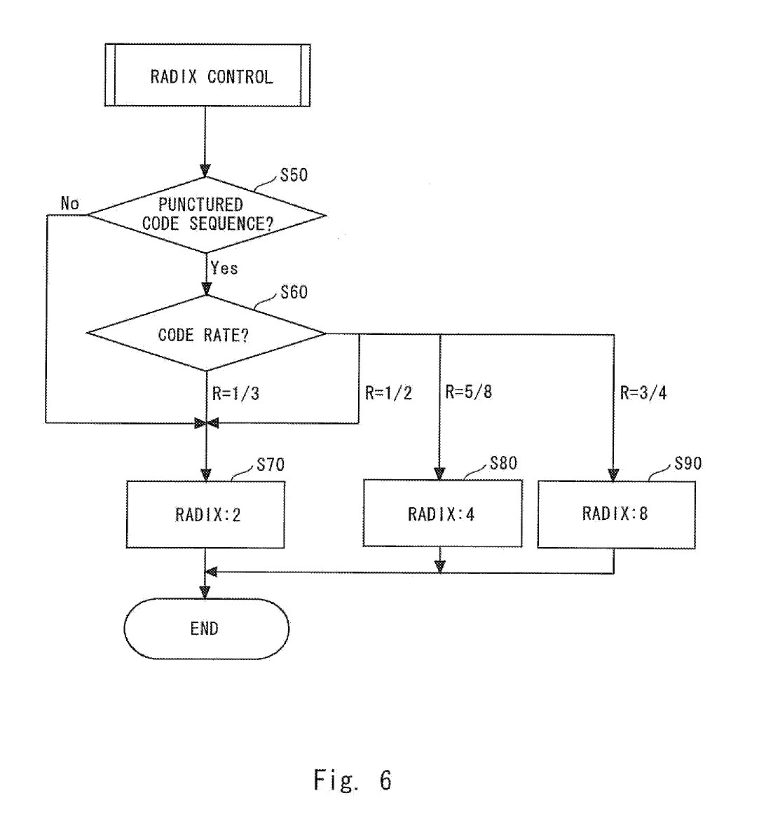

Further, the radix of the ACS processing is not necessarily controlled according to a comparison with a threshold as in the above-described control of the radix control unit 280, as long as the radix is larger as the puncturing rate is higher. For example, the radix control unit may include a table which associates a code rate R with a radix and control a radix of the ACS processing unit in such a way that a radix is a value associated with the code rate R. FIG. 6 is a flowchart showing an example of radixes in this example. For example, the table may contain the following code rate R and radix: “R:1/3, radix: 2”, “R:1/2, radix: 2”, “R:5/8, radix: 4”, and “R:3/4, radix: 8”.

In this case also, the radix control unit controls a radix to be 2 for an unpunctured code sequence just like the ACS processing unit 262 (No in S50, S70). For a punctured code sequence, it refers to the table and controls a radix to be 2, 2, 4 or 8, when a code rate R is 1/3, 1/2, 5/8 or 3/4, respectively (Yes in S50, S60 to S90).

The table may be stored in a register to which the radix control unit can refer, so that the table can be edited externally.

It is apparent that the present invention is not limited to the above embodiments, but may be modified and changed without departing from the scope and spirit of the invention.

What is claimed is:

1. A decoding method comprising:
changing a radix of ACS processing in accordance with a puncturing rate of data to be decoded.

2. The decoding method according to claim 1, further comprising:
increasing a value of said radix in response to said puncturing rate.

3. The decoding method according to claim 1, further comprising:
increasing said radix when said puncturing rate is larger than predetermined threshold.

4. The decoding method according to claim 1, wherein
a value of said radix is 2, 4, or 8.

5. A decoding device comprising:
an ACS processing unit having a plurality of ACS processing blocks, each of said ACS processing blocks performing ACS processing;
a depuncturing unit receiving a punctured data and outputting a puncturing rate of said punctured data; and
a control unit determining the number of said ACS processing blocks used for decoding in said ACS processing unit in accordance with said puncturing rate.

6. The decoding device according to claim 5, wherein
said ACS processing unit includes cascade connected ACS processing blocks.

7. The decoding device according to claim 5, wherein
said control unit increases the number of said ACS blocks used for decoding when said received puncturing rate is larger than a predetermined threshold.

8. The decoding device according to claim 5, wherein
said control unit increases the number of said ACS blocks used for decoding in response to said puncturing rate.

9. The decoding device according to claim 5, further comprising:
an header analysis unit analyzing a header relative to said data to be decoded, obtaining said puncture rate from said header, and outputting said obtained puncture rate to said depuncturing unit, wherein
said depuncturing unit outputting said puncture rate received front said header analysis unit to said control unit.

10. The decoding device according to claim 5, further comprising:
a first branch metric calculation unit calculating a branch metric based on depunctured data output from said depuncturing unit; and
a second branch metric calculation unit calculating a branch metric based on said depunctured data and a signal output from said control unit, said signal being output when said control unit increases the number of said ACS blocks used for decoding.

11. The decoding device according to claim 10, further comprising:
an AND gate operating based on said signal and said deunctured data.

12. The decoding device according to claim 5, further comprising:
an AND gate operating based on a first signal output from said control unit and a second signal output from said ACS processing unit, said first signal being output when said control unit increases the number of said ACS blocks used for decoding.
